(19) United States
(12) Patent Application Publication
(10) Pub. No.: US 2016/0208522 A1
(43) Pub. Date: Jul. 21, 2016

(54) MOTOR VEHICLE LOCK

(71) Applicant: BROSE SCHLIESSSYSTEME GMBH & CO. KG, Wuppertal (DE)

(72) Inventors: Joerg Reinert, Remscheid (DE); Peter Pszola, Bonn (DE); Christian Klinger, Neubrunn (DE); Matthias Koch, Waldbuettelbrunn (DE)

(21) Appl. No.: 14/913,799

(22) PCT Filed: Aug. 22, 2014
(86) PCT No.: PCT/EP2014/067899

§ 371 Date: Feb. 23, 2016

(30) Foreign Application Priority Data
Aug. 23, 2013 (DE) 10 2013 109 165.2

(51) Int. Cl. E05B 81/06; H02K 3/04; H02K 1/27; H02K 1/12; E05B 81/16; E05B 81/30

(52) U.S. Cl. CPC E05B 81/06; E05B 81/16; E05B 81/30; H02K 1/27; H02K 1/12; H02K 3/04

(57) ABSTRACT

The invention relates to a motor vehicle lock having an actuating element, in particular a control shaft, which can be adjusted about an actuating element axis, and a drive for adjusting the actuating element, the drive having a rotor which is assigned to the actuating element and which has a permanent magnet arrangement, and a stator with a coil arrangement comprising at least two coils. It is proposed that the stator has at least two poles, via which a magnetic field which is generated by the coil arrangement is guided, and wherein, possibly in a manner which is dependent on the position of the rotor, at least one pole of the stator reaches up to an end side of the rotor apart from an axial gap in relation to the actuating element axis.

### CROSS-REFERENCE TO RELATED APPLICATIONS

This application is a national stage application under 35 U.S.C. 371 of Inter-national Patent Application Serial No. PCT/EP2014/067899, entitled “Kraftfahrzeugschloss,” filed Aug. 22, 2014, which claims priority from German Patent Application No. DE 10 2013 109 165.2, filed Aug. 23, 2013, the disclosures of which are incorporated herein by reference.

### FIELD OF THE TECHNOLOGY

The application relates to a motor vehicle lock and to a method for actuating a motor vehicle lock.

### BACKGROUND

The motor vehicle lock in question is used in all types of closure elements of a motor vehicle. These include, in particular, side doors, rear doors, tailgates, trunk lids or engine hoods. Said closure elements can in principle also be configured in the manner of sliding doors.

Current motor vehicle locks are equipped with a whole series of functions which can be triggered in a motorized manner by means of electric drives. Here, firstly compactness which is as high as possible and secondly costs which are as low as possible are of particular significance.

The known motor vehicle lock (DE 10 2008 012 563 A1), from which the invention proceeds, has a drive for an adjustable functional element, which drive is configured in the manner of a direct drive. A disadvantage of the direct drive there, however, is its low degree of efficiency and its less than optimum torque behavior.

### SUMMARY

The application is based on the problem of increasing the degree of efficiency of the drive there and optimizing its torque behavior.

The motor vehicle lock according to the proposal is equipped with an actuating element which can be adjusted about an actuating element axis, such as a control shaft, and a drive for adjusting the actuating element, the drive having a rotor which is assigned to the actuating element and has a permanent magnet arrangement, and a stator with a coil arrangement comprising at least two coils.

The fundamental consideration is essentially that particularly satisfactory degrees of efficiency and high torques can be realized with a compact construction by way of the guidance of the magnetic field which is generated by the coil arrangement via magnetically conducting poles, of which at least one pole reaches up to an end side of the rotor apart from an axial gap in relation to the actuating element axis. Poles of this type are generally also called “teeth”.

In order to interpret the expression “end side of the rotor”, it is assumed that a rotor always has a circumferential side which rotates about the rotor axis and two end sides which point in opposite directions. In a cylindrical rotor, the circumferential side is a cylinder circumferential face and the two end sides are circular faces which are oriented perpendicularly with respect to the rotor axis. Here, the expression “axial gap” means that the gap bridges a distance in the axial direction in relation to the actuating element axis.

According to the proposal, the drive which is assigned to the motor vehicle lock is therefore constructed in the manner of an axial flux machine. The working magnetic field which is crucial for the motorized adjustment of the actuating element is oriented, here, axially in relation to the rotor axis.

A further increase in the degree of efficiency can be achieved in accordance with an embodiment by virtue of the fact that the poles enclose the rotor on both sides, with the result that targeted guidance of the magnetic field which is generated by the coil arrangement is possible by way of low structural outlay.

One embodiment which is particularly interesting under cost aspects is described herein. Here, the rotational mounting of the actuating element is utilized at the same time for the rotational mounting of the rotor. This dual utilization of the rotational mounting is cost-effective and is additionally advantageous under assembly aspects. In an embodiment, the actuating element can be attached together with the rotor to the stator for assembly. On account of the mounting of the rotor which is realized in the above way via the mounting of the actuating element, said attachment can be realized in a particularly simple mechanical way. It would even be conceivable theoretically that said attachment takes place mechanically without contact.

In an embodiment, the drive serves to set different functional states of the motor vehicle lock. Examples of this are the functional states “locked”, “unlocked”, “theft-proof”, “locked, child-proof” and “unlocked, child-proof”.

The functional states of the motor vehicle lock which are addressed above relate to the possibility of opening a motor vehicle door or the like by means of an internal door handle and by means of an external door handle. In the functional state “locked”, opening can be carried out from the inside, but not from the outside. In the functional state “unlocked”, opening can be carried out both from the inside and from the outside. In the functional state “theft-proof”, opening can be carried out neither from the inside nor from the outside. In the functional state “locked, child-proof”, unlocking can be carried out from the inside, but opening cannot be carried out either from the inside or from the outside. In the functional state “unlocked, child-proof”, opening can be carried out from the outside, but not from the inside.

In an embodiment, the functional element which determines the respective functional state of the motor vehicle lock is configured as a wire or strip which can be bent into different functional positions in one variant. The flexibility with regard to the arbitrary setting of functional states can be utilized fully by way of a functional element of this type which is configured as a wire or strip.

An interesting aspect in the solution according to the proposal in accordance with an embodiment is the fact that steady-state energization of the coil arrangement can lead to magnetically stable drive positions of the actuating element. Here, the wording “magnetically stable” means that the energization of the coil arrangement with the resulting magnetic field ensures that, in the case of a deflection out of the respective drive position, the actuating element is always driven back into said drive position. It goes without saying that this relates to a deflection of the actuating element in both adjusting directions. Here, the expression “steady-state energization” means that the energization which is set does not change during the time period. Here, the expression “energization” is to be understood generally and comprises both the application of an electric voltage and the introduction of an electric current into the coil arrangement. Here, the voltage or the current can also be pulsed or the like. In the simplest case, a constant voltage is switched onto the relevant part of the coil arrangement for steady-state energization in the above sense.

According to a further teaching in accordance with an embodiment, a method for actuating a motor vehicle lock according to the proposal is described.

An essential point according to the further teaching is the consideration of energizing the coil arrangement differently in a steady-state for moving to at least two magnetically stable drive positions of the actuating element.

An embodiment, provides a motor vehicle lock having an actuating element, in particular a control shaft, which can be adjusted about an actuating element axis, and a drive for adjusting the actuating element, the drive having a rotor which is assigned to the actuating element and which has a permanent magnet arrangement, and a stator with a coil arrangement comprising at least two coils, wherein the stator has at least two poles, via which a magnetic field which is generated by the coil arrangement is guided, and wherein, possibly in a manner which is dependent on the position of the rotor, at least one pole of the stator reaches up to an end side of the rotor apart from an axial gap in relation to the actuating element axis.

In an embodiment, the poles reach in each case in the axial direction up to two opposite end sides of the rotor, in each case apart from a gap, and thus enclose the rotor on both sides.

In an embodiment, the gap extends along a gap plane, and in some embodiments the gap plane extends perpendicularly with respect to the actuating element axis.

In an embodiment, each pole is assigned a coil of the coil arrangement, and in some embodiments each pole extends through the coil which is assigned to it.

In an embodiment, a conducting arrangement is provided which couples at least two poles of the stator to one another magnetically, and in some embodiments the conducting arrangement is of unlaminated configuration.

In an embodiment, wherein the permanent magnet arrangement is magnetized diametrically or axially in relation to the actuating element axis, and in some embodiments the permanent magnet arrangement is of elongate or flat configuration in the direction of the magnetization axis.

In an embodiment, the actuating element is mounted rotationally by means of a bearing arrangement on a carrier part which is different than the stator, in particular on a housing part, of the motor vehicle lock, and wherein the rotor is mounted rotationally exclusively via the bearing arrangement of the actuating element, and in some embodiments the actuating element can be attached together with the rotor to the stator for assembly.

In an embodiment, the motor vehicle lock has a lock mechanism which can be moved into different functional states such as “locked”, “unlocked”, “theft-proof”, “locked, child-proof” and “unlocked, child-proof”, at least one adjustable functional element being provided in order to set the various functional states, the actuating element, in particular the control shaft, being in drive engagement or being capable of being brought into drive engagement with the functional element, or being a constituent part of the functional element. In some embodiments, the functional element is supported on a control section of the control shaft.

In an embodiment, the functional element is configured as a wire or strip and can be deflected into different functional positions, and in some embodiments the functional element is configured as a resilient wire or strip and can thus be bent as a bending functional element into different functional positions.

In an embodiment, the coil arrangement has at least two, such as precisely two, coil pairs which are at least also actuated in pairs, and in some embodiments in that the two coils of a coil pair are connected electrically in series.

In an embodiment, at least one coil of the coil arrangement is oriented with its coil axis parallel to the actuating element axis.

In an embodiment, at least two magnetically stable drive positions of the actuating element can be moved to by way of different steady-state energization of the coil arrangement.

In an embodiment, at least two magnetically stable drive positions can be moved to in an energization direction which is assigned to the respective drive position by way of energization of the coils of the coil arrangement in a coil combination which is assigned to the respective drive position.

An embodiment provides a method for actuating a motor vehicle lock as described herein, wherein the coil arrangement is energized differently in a steady state for moving to at least two magnetically stable drive positions of the actuating element.

In an embodiment, in order to move to at least two magnetically stable drive positions, the coils of the coil arrangement in a coil combination which is assigned to the respective drive position are energized in a steady state in an energization direction which is assigned to the respective drive position.

### BRIEF DESCRIPTION OF THE FIGURES

In the following text, the invention will be explained in greater detail using a drawing which illustrates merely one exemplary embodiment and in which:

FIG. 1 shows the constituent parts which are essential for the invention of a motor vehicle lock according to the proposal,

FIG. 2 shows the drive of the motor vehicle lock according to FIG. 1 in a diagrammatic, perspective illustration, and

FIG. 3 shows the drive of the motor vehicle lock according to FIG. 1 in a further embodiment in a diagrammatic, perspective illustration.

### DETAILED DESCRIPTION

It may be noted to begin with that the drawing shows only those components of the motor vehicle lock according to the proposal which are necessary to explain the teaching. Accordingly, a lock latch which interacts in a customary manner with a lock bolt or the like and which is held by means of a locking pawl in a main closed position and in a possibly present pre-closing position is not shown in the drawing.

The motor vehicle lock has an adjusting element 2 which can be adjusted about an actuating element axis 1 and, here is a control shaft. All comments in respect of the control shaft 2 apply analogously to all other types of actuating elements.

In principle, the actuating element 2 can be configured in multiple pieces, for example can have at least two shaft sections which are coupled to one another, in particular are connected to one another, and are oriented onto the actuating element axis 1. However, it is also conceivable that the actuating element 2 is configured in one piece.

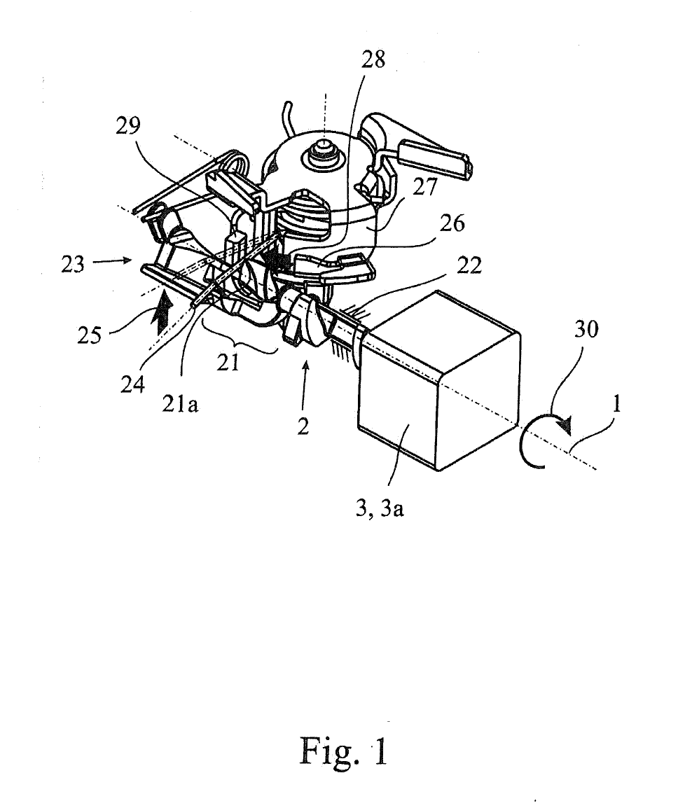

Furthermore, the motor vehicle lock is equipped with a drive 3 for adjusting the actuating element 2. Here, the drive 3 serves to set different functional states of the motor vehicle lock, which will be explained in detail further below. FIG. 1 shows the drive 3 with a drive housing 3a which does not necessarily have to be provided, however, for the solution according to the proposal.

The drive 3 has a rotor 4 which is assigned to the actuating element 2 and has a permanent magnet arrangement 5, and a stator 6 with a coil arrangement 7 comprising at least two coils 8-11, comprising four coils 8-11 here. It has been shown in tests that a coil arrangement 7 comprising three coils can be advantageous with regard to the generation of drive moment.

Here the drive 3 is configured in the manner of a direct drive. This means that no step-up or step-down gear mechanism is provided between the actuating element 2 and the rotor 4.

The stator 6 of the drive 3 has at least two poles, four poles 12-15 here, via which a magnetic field which is generated by the coil arrangement 7 is guided. Here, the poles 12-15 reach up to an end side 18, 19 of the rotor 4, apart from an axial gap 16, 17 in relation to the actuating element axis 1. In principle, this can also be provided only for one part of the poles 12-15.

According to the proposal, the fundamental structure of an axial flux motor corresponds to the drive 3 of the motor vehicle lock. Comparatively high torques can be generated with a compact design by way of the axial working magnetic field in relation to the rotor axis which is critical for the generation of drive moments, with the result that the drive 3 of the motor vehicle lock according to the proposal is particularly well suited as a direct drive.

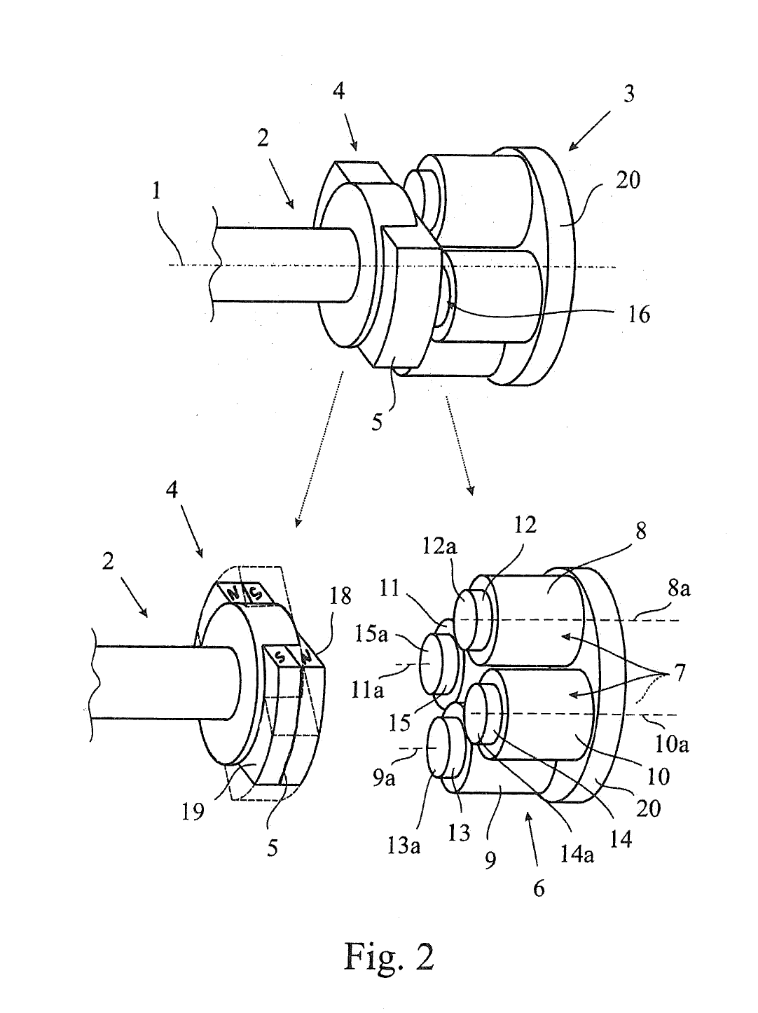

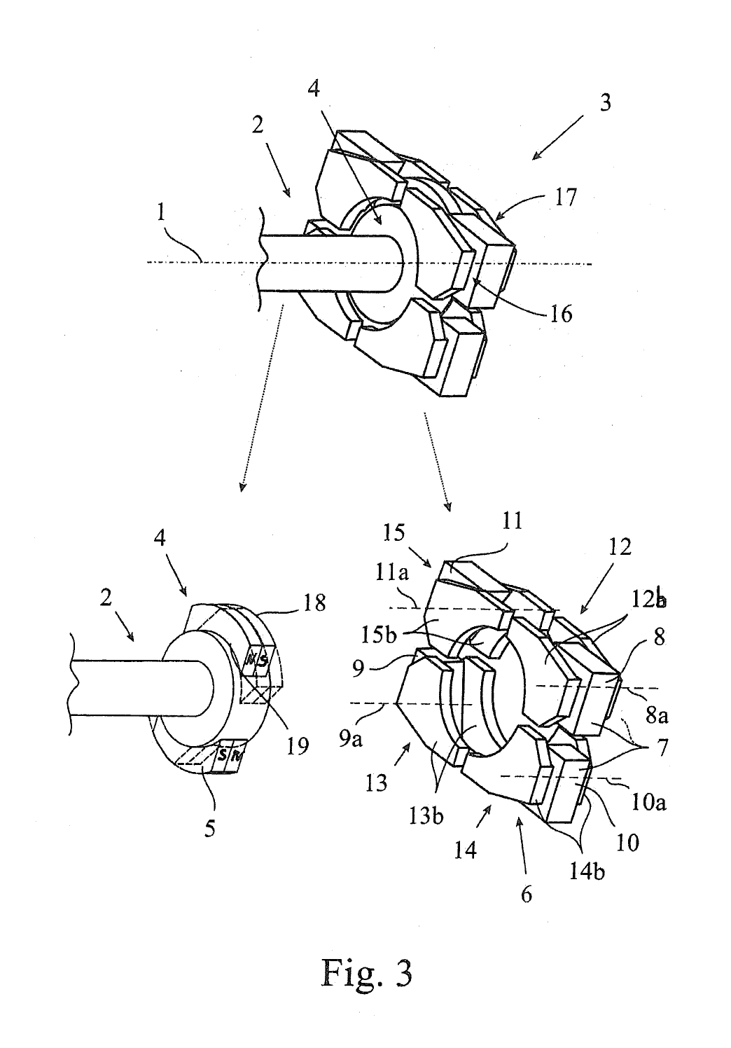

In the exemplary embodiment of structurally particularly simple design which is shown in FIG. 2, the poles 12-15 of the stator 6 reach only up to an end side 18 of the rotor 4. In the particularly low-loss refinement according to FIG. 3, the poles 12-15 reach in each case in the axial direction on two opposite end sides 18, 19 of the rotor 4 in each case as far as a gap 18, 19. This achieves a situation where the poles 12-15 enclose the rotor 4 on both sides, that is to say on both end sides 18, 19 of the rotor 4.

In the exemplary embodiment which is shown in FIG. 2, the poles 12-15 are configured as substantially cylindrical pole shoes which in each case have a flat pole face 12a-15a which faces the rotor 4. In the exemplary embodiment which is shown in FIG. 3, the poles 12-15 have in each case two pole laminations 12b-15b which are oriented parallel to one another and which enclose the rotor 4 on both sides as explained above. Here, the pole laminations 12b-15b are connected in a magnetically conducting manner. It is conceivable in this context that the pole laminations 12b-15b are magnetically coupled to an iron core of the coils 8-11.

The gap 16, 17 between the rotor 4 and the poles 12-15 is present for all poles 12-15 in the case of a circular rotor 4, independently of the position of the rotor 4. Here, however, the rotor 4 is of elongate configuration in a way which is still to be explained, with the result that the rotor 4 does not sweep over all the poles 12-15 at the same time. Correspondingly, it is the case that the gap 16, 17 is formed in a manner which is dependent on the position of the rotor 4.

Here, the gap 16, 17 extends along a gap plane which, in an embodiment, extends perpendicularly with respect to the actuating element axis 1. This corresponds to the above requirement that the working magnetic field is oriented parallel to the actuating element axis 1. By virtue of the fact that, here, the coil axes are likewise oriented parallel to the actuating element axis 1, a deflection of the magnetic field which is generated by the coil arrangement 7 is not necessary, which further increases the degree of efficiency of the drive 3.

In the exemplary embodiment which is shown, each pole 12-15 of the drive 3 is assigned a coil 8-11 of the coil arrangement 7, each pole 12-15 extending through the coil 8-11 which is assigned to it. To this extent, the poles 12-15 serve at the same time as magnetic cores for the respective coils 8-11.

In the exemplary embodiment which is shown in FIG. 2, the poles 12-15 of the stator 6 are coupled magnetically to one another by means of a conducting arrangement 20, with the result that the conducting arrangement 20 ensures a closed magnetic circuit between the poles 12-15 of the stator 6. Here, the conducting arrangement 20 is of unlaminated configuration, which leads to a particularly inexpensive implementation. The unlaminated implementation of the conducting arrangement 20 is acceptable, in particular, in the case of the method of operation according to the proposal of the drive 3, which method of operation is still to be explained, since low eddy current losses are to be expected in the case of said method of operation.

The conducting arrangement 20 can be a flat plate which is oriented perpendicularly with respect to the actuating element axis 1 and from which the poles 12-15 protrude parallel to the actuating element axis 1.

In principle, a series of advantageous implementation possibilities are conceivable for the type of permanent magnet arrangement 5. In one variant, the permanent magnet arrangement 5 is magnetized diametrically in relation to the actuating element axis 1, as can be gathered from the illustrations according to FIGS. 2 and 3. In principle, the permanent magnet arrangement 5 can also be a multiple-pole permanent magnet arrangement 5.

For the case of a diametrically magnetized permanent magnet arrangement 5, the permanent magnet arrangement 5 can be of elongate configuration in the direction of the magnetization axis. In the present case, the “magnetization axis” denotes the axis, on which the north and south pole of the permanent magnet arrangement 5 lie. The exciter magnetic field and therefore the torque characteristic of the drive 3 can be set in a targeted way using the shape of the permanent magnet arrangement 5.

As an alternative, it can be provided that the permanent magnet arrangement 5 is magnetized axially, as indicated in the drawing. The magnetization axis can then be oriented parallel to the actuating element axis 1. Here, the permanent magnet arrangement 5 has two sections which, starting from the actuating element axis 1, extend in opposite directions and are magnetized in an axially opposed manner. Here, the directions of extent are oriented perpendicularly with respect to the actuating element axis 1. Finally, the permanent magnet arrangement 5 correspondingly has two permanent magnets which are magnetized in an opposed manner. Here, the permanent magnet arrangement 5 is of flat configuration in the direction of the magnetization axis.

The permanent magnet arrangement 5 can have at least one hard ferrite magnet and/or at least one rare earth magnet and/or at least one plastic bonded magnet. Furthermore, the actuating element 2, in particular the control shaft 2, can also be magnetized itself in a corresponding design and can accordingly form the permanent magnet arrangement 5. This is possible, for example, if the actuating element 2 consists at any rate partially or completely, of an above material, in particular of a magnetizable plastic material.

A particularly interesting feature of the exemplary embodiment which is shown in FIG. 1 is the fact that the actuating element 2 is configured as a control shaft with at least one axial control section 21 for conducting out control movements. The function of the control section 19 will be explained further below.

The permanent magnet arrangement 5 is arranged on the end side of the control shaft 2. It can be clipped onto the control shaft 2, can be adhesively bonded onto the control shaft 2, or can be fastened to the control shaft 2 in some other way.

In an embodiment the rotor 4 itself provides a conducting arrangement, in order to ensure the magnetic circuit. A conducting arrangement 20 of this type might be provided in FIG. 2 on that end side 19 of the rotor 4 which faces away from the coil arrangement 7.

The mounting of the rotor 4 is interesting in the exemplary embodiments which are shown. Here, the actuating element 2, in particular the control shaft 2, is mounted rotationally by means of a bearing arrangement 22 on a carrier part of the motor vehicle lock which is different than the stator 6, here on a housing part, the rotor 4 being mounted rotationally exclusively via the bearing arrangement 22 of the actuating element 2. The rotational mounting of the rotor 4 therefore takes place independently of the stator 6.

In the exemplary embodiment which is shown in FIG. 2, it is the case that the actuating element 2 can be attached together with the rotor 4 to the stator 6 for assembly. A bearing connection between the rotor 4 and the stator 6 is not required in the case of said attachment. It is therefore possible in principle that the stator 6 can be mounted on a carrier part or a housing part of the motor vehicle lock before the actuating element 2 is mounted together with the rotor 4.

As has already been indicated, the drive 3 serves to set various functional states of the motor vehicle lock. For this purpose, the motor vehicle lock first of all has a lock mechanism 23 which can be moved into different functional states such as “locked”, “unlocked”, “theft-proof”, “locked, child-proof” and “unlocked, child-proof”. The meaning of said functional states for the possibility to open the motor vehicle door or the like from the inside and from the outside has been explained in the general part of the description.

Here, an adjustable functional element 24 is provided for setting the various functional states, the actuating element 2, the control shaft 2 here, being in or being capable of being moved into drive engagement with the functional element 24. It is also conceivable that the actuating element 2, the control shaft 2 here, is itself a constituent part of the functional element 24.

In some embodiments, the functional element 24 is supported on the control section 19 of the control shaft 2. Depending on the position of the control shaft 2, the functional element 24 is adjusted substantially perpendicularly with respect to the actuating element axis 1, as shown in FIG. 1 by way of the movement arrow 25 and by way of the dashed illustration of the functional element 24. As shown in FIG. 1, the control section 21 can be equipped with a cam 21a, on which the functional element 24 is supported correspondingly. Depending on the position of the control shaft 2, the support of the functional element 24 on the cam 21a leads to a resulting deflection of the functional element 24 in the direction of the movement arrow 25.

The control shaft 2 can then be moved by means of the drive 3 into at least two control positions, here into a total of five control positions, in order for it to be possible to set the functional states of the motor vehicle lock, here the functional states “locked”, “unlocked”, “theft-proof”, “locked, child-proof” and “unlocked, child-proof”.

The construction of the motor vehicle lock according to the proposal is of particularly simple design by virtue of the fact that the functional element 24 is configured as a wire and can be deflected into different functional positions along the movement arrow 25. It is in principle also conceivable that the functional element 24 is configured as a strip. Here, it is further the case that the functional element 24 is configured as a resilient wire or strip and thus can be moved as a bending functional element into the different functional positions.

In the following text, the method of operation of the motor vehicle lock in the functional states “unlocked” and “unlocked, child-proof” will be explained. Otherwise, in order to explain the fundamental method of operation of the motor vehicle lock with a resilient functional element 24, reference may be made to the international patent application WO 2009/040074 A1 which is attributed to the applicant and the content of which to this extent is made the subject matter of the present application.

In the functional state “unlocked”, the functional element 24 is in its lower (in FIG. 1) position which is shown by a solid line. The functional element 24 is therefore situated in the movement region of an inner actuating lever 26 which is coupled to an internal door handle in the assembled state, and in the movement region of an outer actuating lever 27 which is coupled to an external door handle in the assembled state. An adjustment of the inner actuating lever 26 or the outer actuating lever 27 in the direction of the movement arrow 28 leads to the functional element 24 following the movement of the respective lever 26, 27 perpendicularly with respect to its extent, with which lever 26, 27 the locking pawl 29 (merely indicated in FIG. 1) comes into contact and in turn drives and lifts out in the direction of the movement arrow 28.

An adjustment of the control shaft 2 in the direction of the movement arrow 30 by 90° out of the position which is shown in FIG. 1 leads to the setting of the functional state “unlocked, child-proof”. In this state, the functional element 24 is situated in the position which is shown using a dashed line in FIG. 1. An adjustment of the inner actuating lever 26 in the direction of the movement arrow 28 therefore has no effect on the functional element 24 and the locking pawl 29. However, the functional element 24 is situated in the movement region of the outer actuating lever 27, with the result that lifting out of the locking pawl 29 and therefore opening of the motor vehicle door by the outer actuating lever 27 and therefore via the external door handle is possible.

In an analogous manner to the setting of the above-described functional states “unlocked” and “unlocked, child-proof”, all other functional states addressed above can also be implemented solely by way of a corresponding adjustment of the control shaft 2. The drive 3 is designed to move to all functional states correspondingly.

It has already been noted that all gear mechanism components between the rotor 4 and the actuating element 2 can be dispensed with as a result of the configuration of the drive 3 as a direct drive. For this reason, the drive 3 is of mechanically non-self-locking configuration, which makes unproblematic manual setting of functional states of the motor vehicle lock possible.

The design of the coil arrangement 7, in particular the design and arrangement of the coils 8-11, is given very special significance in the present case. In the present case the coil arrangement 7 has at least two, here precisely two, coil pairs 8, 9; 10, 11 which are at least also actuated in pairs. Here, the two coils 8, 9; 10, 11 are connected in series electrically.

For the motor vehicle lock which is shown, a symmetrical arrangement of the coils 8-11 in relation to the actuating element axis 1 has proven its worth. Accordingly, the two coils 8, 9; 10, 11 of a coil pair are arranged so as to lie diametrically opposite one another in relation to the actuating element axis 1, the coil axes 8a-11a being oriented in each case parallel to the actuating element axis 1 or the rotor axis.

In principle, a wide variety of advantageous variants for the orientation of the coil arrangement 7 are conceivable. This is due to the fact that there is the possibility of conducting magnetic flux through a corresponding magnetic conducting arrangement. For example, it can be advantageous to orient at least part of the coils 8-11 of the coil arrangement 7 perpendicularly with respect to the actuating element axis 1, the coils 8-11 then can be wound around a yoke-like conducting arrangement for diverting the magnetic flux.

It has already arisen from the above explanations that the drive 3 according to the proposal is not primarily configured as a rotary drive which performs a multiplicity of revolutions in order to adjust the actuating element 2. Rather, the drive 3 can be a type of stepping motor which moves to a predefined number of positions in a targeted manner. It can be provided here that the drive 3 does not perform more than one revolution, or even less than one revolution. It is also conceivable, however, that the drive 3 is of freely rotating configuration in such a way that it can perform any desired number of revolutions in a stepped manner. Here, the fact is advantageous that only low eddy current losses are to be expected in the poles 12-15 and in the conducting arrangement 20 during the targeted moving according to the proposal to the drive positions. A lamination, in particular of the conducting arrangement 20, can therefore be dispensed with.

An interesting feature in the case of the drive 3 according to the proposal is, above all, the fact that at least two, a total of five here, magnetically stable drive positions of the actuating element 2 are moved to by way of different steady-state energization of the coil arrangement 7. In principle, even a total of eight magnetically stable drive positions of the actuating element 2 can be moved to here.

In the context of the above-addressed interpretation of the expression “steady-state energization”, the energization is merely connected, and is not regulated with regard to a defined movement sequence or the like. It has also already been explained that the expression “magnetically stable drive position” in the present case means that the actuating element 2 always pushes into the corresponding drive position during the energization, to be precise independently of the direction of a deflecting force which acts from the outside. This means that the drive positions which correspond to the corresponding control positions of the actuating element 2 can be moved to without the necessity of an end stop or the like. This reduces the wear and noise and simplifies the mechanical construction.

It is therefore the case that at least two magnetically stable drive positions can be moved to by way of energization of the coils 8-11 of the coil arrangement 7 in a coil combination which is assigned to the respective drive position in an energization direction which is assigned to the respective drive position. The drive position which is moved to results exclusively from the energized coil combination and the energization direction. This makes particularly simple design of a control device which is assigned to the coil arrangement 7 possible.

According to a further teaching, the above-explained method per se is described for actuating a motor vehicle lock according to the proposal. It is essential according to said method that the coil arrangement 7 is energized differently in a steady state for moving to at least two magnetically stable drive positions of the actuating element 2. Reference may be made to all the above comments which relate to the actuation of the motor vehicle lock according to the proposal.

It may be summarized that targeted moving to predefined drive positions which correspond in each case to a functional state of the motor vehicle is possible by way of the drive 3 according to the proposal, without wear-intensive and noise-intensive commutation being required. This results overall in high reliability, since no sliding contacts are necessary, the drive 3 is constructed only from a few individual parts, and no end stops are required on account of the magnetic stability of the drive positions. The material costs are reduced by the low number of components and, in particular, by virtue of the fact that only a single drive is required for setting a multiplicity of functional states. This in turn is associated with a weight reduction in comparison with the known motor vehicle locks. Furthermore, the possibility of particularly simple assembly arises if, as explained above, the mounting of the rotor 4 is realized independently of the stator 6.

It may be noted that the drive 3 according to the proposal can be utilized within the motor vehicle lock in very different ways. In addition to the setting of functional states, the drive 3 can be utilized, for example, for motorized lifting out of the locking pawl 29, since only small actuating travels are required for this purpose. In principle, however, the use in the context of a closing aid or the like is also conceivable.

Furthermore, it may be noted that the operating state of the rotor 4 of the drive 3 can be detected in a particularly simple way. In one variant, it is provided that the magnetic field of the permanent magnet arrangement 5 is detected by means of a sensor device (not shown), and that the operating state, here the position, of the rotor 4 is determined from the sensor measured values of the sensor device. The sensor device can be, for example, a Hall sensor or a plurality of Hall sensors, an MR sensor or a plurality of MR sensors or the like. The expression “determination of the operating state of the rotor 4” is to be understood broadly in the present case. It comprises not only the determination of the above functional states, but rather also the determination of information which makes a plausibility check possible, for example, together with the data of a separate sensor, for example a rotary sensor. Additional switching or frictional forces are not associated with this. The necessary electric cabling can be accommodated in a possibly present bearing plate of the drive 3. With a corresponding design, in particular a corresponding signal coding, a transmission of the sensor measured values via only one electric line is conceivable, which is particularly cost-effective. This detection of the operating state of the rotor 4 can be applied fundamentally to all conceivable designs of the drive 3, without it coming down to the implementation of an axial flux machine.

Finally, it may be noted for clarification purposes that the components of the motor vehicle lock do not necessarily have to be accommodated in one and the same housing. In particular, it can be advantageous to provide the drive 3 in a housing which is otherwise of separate configuration from the motor vehicle lock, with the result that the motor vehicle lock is arranged in a distributed manner to this extent.

1. A motor vehicle lock having an actuating element, which can be adjusted about an actuating element axis, and a drive for adjusting the actuating element, the drive having a rotor which is assigned to the actuating element and which has a permanent magnet arrangement, and a stator with a coil arrangement comprising at least two coils, wherein the stator has at least two poles, via which a magnetic field which is generated by the coil arrangement is guided, and wherein, possibly in a manner which is dependent on the position of the rotor, at least one pole of the stator reaches up to an end side of the rotor apart from an axial gap in relation to the actuating element axis.

2. The motor vehicle lock as claimed in claim 1, wherein the poles reach in each case in the axial direction up to two opposite end sides of the rotor, in each case apart from a gap, and thus enclose the rotor on both sides.

3. The motor vehicle lock as claimed in claim 1, wherein the gap extends along a gap plane.

4. The motor vehicle lock as claimed in claim 1, wherein each pole is assigned a coil of the coil arrangement.

5. The motor vehicle lock as claimed in claim 1, wherein a conducting arrangement is provided which couples at least two poles of the stator to one another magnetically.

6. The motor vehicle lock as claimed in claim 1, wherein the permanent magnet arrangement is magnetized diametrically or axially in relation to the actuating element axis.

7. The motor vehicle lock as claimed in claim 1, wherein the actuating element is mounted rotationally by means of a bearing arrangement on a carrier part which is different than the stator of the motor vehicle lock, and wherein the rotor is mounted rotationally exclusively via the bearing arrangement of the actuating element.

8. The motor vehicle lock as claimed in claim 1, wherein the motor vehicle lock has a lock mechanism which can be moved into different functional states such as “locked”, “unlocked”, “theft-proof”, “locked, child-proof” and “unlocked, child-proof”, at least one adjustable functional element being provided in order to set the various functional states, the actuating element being in drive engagement or being capable of being brought into drive engagement with the functional element, or being a constituent part of the functional element.

9. The motor vehicle lock as claimed in claim 1, wherein the functional element is configured as a wire or strip and can be deflected into different functional positions.

10. The motor vehicle lock as claimed in claim 1, wherein the coil arrangement has at least two coil pairs which are at least also actuated in pairs.

11. The motor vehicle lock as claimed in claim 1, wherein at least one coil of the coil arrangement is oriented with its coil axis parallel to the actuating element axis.

12. The motor vehicle lock as claimed in claim 1, wherein at least two magnetically stable drive positions of the actuating element can be moved to by way of different steady-state energization of the coil arrangement.

13. The motor vehicle lock as claimed in claim 1, wherein at least two magnetically stable drive positions can be moved to in an energization direction which is assigned to the respective drive position by way of energization of the coils of the coil arrangement in a coil combination which is assigned to the respective drive position.

14. A method for actuating a motor vehicle lock as claimed in claim 1, wherein the coil arrangement is energized differently in a steady state for moving to at least two magnetically stable drive positions of the actuating element.

15. The method as claimed in claim 14, wherein, in order to move to at least two magnetically stable drive positions, the coils of the coil arrangement in a coil combination which is assigned to the respective drive position are energized in a steady state in an energization direction which is assigned to the respective drive position.

16. The motor vehicle lock as claimed in claim 3, wherein the gap plane extends perpendicularly with respect to the actuating element axis.

17. The motor vehicle lock as claimed in claim 4, wherein each pole extends through the coil which is assigned to it.

18. The motor vehicle lock as claimed in claim 5, wherein the conducting arrangement is of unlaminated configuration.

19. The motor vehicle lock as claimed in claim 6, wherein the permanent magnet arrangement is of elongate or flat configuration in the direction of the magnetization axis.

20. The motor vehicle lock as claimed in claim 7, wherein the actuating element can be attached together with the rotor to the stator for assembly.
